(19) United States
(12) Patent Application Publication
(10) Pub. No.: US 2021/0390511 A1
(43) Pub. Date: Dec. 16, 2021

(54) COMPUTER IMPLEMENTED METHOD OF EMPLOYMENT

(71) Applicant: Discover Podium, LLC, Reno, NV (US)

(72) Inventors: Jacob WARWICK, Reno, NV (US); Rich PETERSON, Incline Village, NV (US)

(73) Assignee: Discover Podium, LLC, Reno, NV (US)

(21) Appl. No.: 16/897,956

(22) Filed: Jun. 10, 2020

(51) Int. Cl. G06Q 10/10; G06F 16/9535

(52) U.S. Cl. CPC G06Q 10/1053; G06F 16/9535

(57) ABSTRACT

A computer implemented method of employment includes inputting a plurality of job related data sets derived from a plurality of sources of job related data into a database stored in a computer system. Job search criteria is collected from an end user. The job search criteria includes at least a description of a new job, a title of the new job and a compensation level of the new job. The job related data sets and the job search criteria are normalized into a consistent format. A computer implemented algorithm is utilized to compare the job search criteria to job related data sets of available jobs or job candidates in the database. The algorithm is utilized to rank the available jobs or job candidates in order of most closely meeting the entirety of the job search criteria based on the comparison.

### BACKGROUND

Traditional (or prior art) job search engines, or job boards, search primarily off of a job “title” to find potential job opportunities for users or that are in search of a job or have posted a job. Traditional search engines are not very targeted to the individual needs of an end user. As such, prior art search engines will often flood an end user with job opportunities that do not meet an end user's needs or are not particularly useful to the end user. An end user may be forced to sift through a lot of irrelevant information before finding a job opportunity or job candidate that the end user considers to be relevant.

For example, an end user may be an employer that posts a job for a director of marketing with 10 years of experience at a compensation level of 250,000/year. Prior art job search engines may provide a list of job candidates to the employer that are based solely on their having the title of “Director of Marketing.” For example, the list of candidates may include people that have only 2 years experience, which may not be enough experience for the posted job. Also, the list of candidates may include people that worked at a fortune 500 company for $500,000/year, which may be too high a compensation level for the posted job. Additionally, the list of candidates may include people that have been at a start-up company as the sole person in the marketing department with a compensation of $100,000/year, which may not be enough experience or the correct experience for the posted job.

Moreover, the job titles are not standardized, wherein a director of marketing in a small to medium sized company will have similar duties as a lower level marketing manager in a larger company. Yet, such marketing managers may not be selected for consideration by a traditional search engine that is searching solely for individuals having the title of: “directors of marketing.”

Additionally, the job prospects or job candidates presented to an end user will not be ranked in any manner and will be presented as a randomly ordered list. That is, prior art job search engines do not evaluate the entirety of an end user's job search criteria and do not rank jobs based on which jobs most closely meet all of the requirements listed within that criteria.

Moreover, prior art job search engines will not learn from experience. As such, prior art job search engines will continue to underperform and will not improve over time.

Accordingly, there is a need for a computer implemented method of employment, which can compare an entirety the requirements of a job search criteria to an entirety of the qualifications of job related data sets of available jobs or job candidates. There is also a need for the method to rank the available jobs or job candidates in order of most closely meeting the entirety of the job search criteria. Moreover, there is a need for the method to be able to learn with each new comparison and each addition of jobs data.

### BRIEF DESCRIPTION

The present disclosure offers advantages and alternatives over the prior art by providing a computer implemented method of employment that is capable of comparing, via computer implemented algorithm, the job search criteria on an end user to job related data sets of available jobs in a database. Additionally, the method is capable of ranking, via the algorithm, the available jobs in order of most closely meeting the entirety of the job search criteria based on the comparing.

A computer implemented method of employment in accordance with one or more aspects of the present disclosure includes inputting a plurality of job related data sets derived from a plurality of sources of job related data into a database stored in a computer system. Job search criteria is collected from an end user. The job search criteria includes at least a description of a new job, a title of the new job and a compensation level of the new job. The job related data sets and the job search criteria are normalized into a consistent format. A computer implemented algorithm is utilized to compare the job search criteria to job related data sets of available jobs or job candidates in the database. The algorithm is utilized to rank the available jobs in order of most closely meeting the entirety of the job search criteria based on the comparison.

Another computer implemented method of employment in accordance with one or more aspects of the present disclosure includes inputting a plurality of job related data sets derived from a plurality of sources of job related data into a database stored in a computer system. Job search criteria is collected from an end user. The end user is searching for a job or posting for a job. The job search criteria includes at least a description of a new job, a title of the new job and a compensation level of the new job. The job related data sets and the job search criteria are normalized into a consistent format. The job search criteria is leveled, wherein leveling includes comparing, via computer implemented algorithm, the job search criteria to job related data sets of available jobs or job candidates in the database, regardless of the title of the new job. Leveling also includes ranking, via the algorithm, the available jobs or job candidates in order of most closely meeting the entirety of the job search criteria based on the comparing.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### DRAWINGS

The disclosure will be more fully understood from the following detailed description taken in conjunction with the accompanying drawings, in which:

FIG. 1A depicts an example of a first portion of a flow diagram of a computer implemented method of employment, in accordance with aspects of the present invention;

FIG. 1B depicts an example of a second portion of the flow diagram of FIG. 1 of a computer implemented method of employment, in accordance with aspects of the present invention;

FIG. 2 depicts an example of a flow diagram of an embodiment of a Leveling Phase of the computer implemented method of employment, in accordance with aspects of the present invention;

FIG. 3 depicts another example of a flow diagram of an embodiment of a Leveling Phase of the computer implemented method of employment, in accordance with aspects of the present invention;

FIG. 4 depicts another example of a flow diagram of an embodiment of a Leveling Phase of the computer implemented method of employment, in accordance with aspects of the present invention;

FIG. 5 depicts an example of a flow diagram of an embodiment of an Interaction Phase of the computer implemented method of employment, in accordance with aspects of the present invention;

FIG. 6 depicts an example of a flow diagram of another embodiment of an Interaction Phase of the computer implemented method of employment, in accordance with aspects of the present invention;

FIG. 7 depicts an example of a computer system for implementing the method of employment, in accordance with aspects of the present invention;

FIG. 8 depicts a list of symbols and their associated descriptions and reference numbers as used in the computer system of FIG. 7, in accordance with aspects of the present invention; and

FIG. 9 depicts an example of a computing environment useable to perform the computer implemented method of employment, in accordance with aspects of the present invention.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

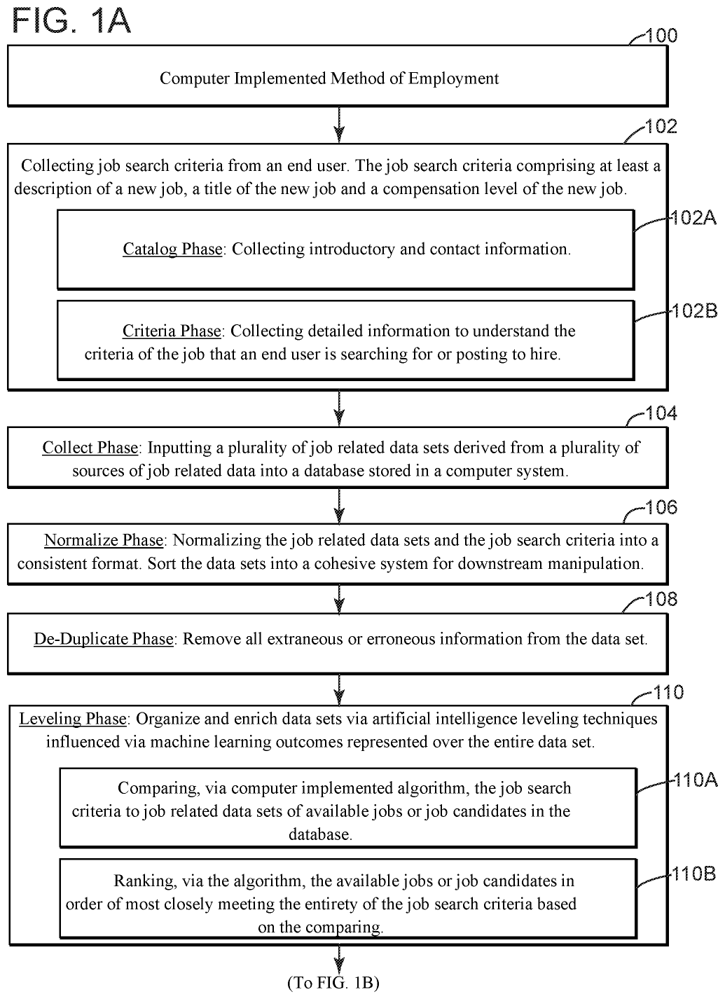

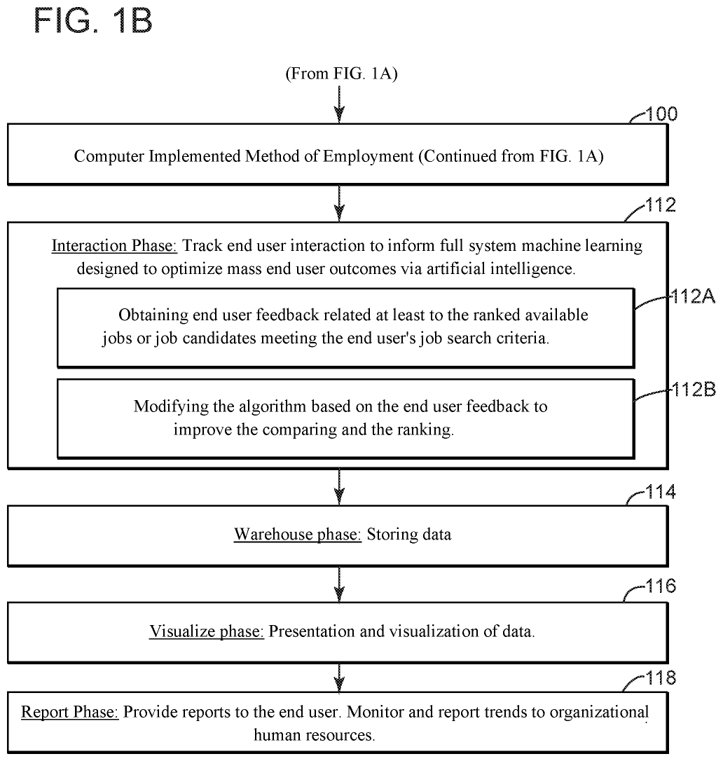

Referring to FIGS. 1A and 1B, an example of a flow diagram of a computer implemented method of employment 100 is depicted in accordance with aspects of the present invention. End users that utilize the method 100 may include people that are searching for a new job (i.e., job candidates), and/or employers that are posting a new job and are looking for people to hire for that job.

The method begins at 102 wherein job search criteria (i.e., job search data) is collected from an end user. The job search criteria may include at least the minimal amount of information required to implement the method 100. For example the job search criteria may include at least a description of a new job, a title of the new job and a compensation level of the new job.

Collecting 102 of the job search criteria from an end user may be split into a “Catalog Phase” 102A and a “Criteria Phase.” 102B. In the Catalog Phase 102A, introductory and contact information may initially be collected from an end user. In the Criteria Phase, more detailed information may be collected in an effort to thoroughly understand the entirety of the requirements that make up the job search criteria for a new job that an end user is seeking or posting.

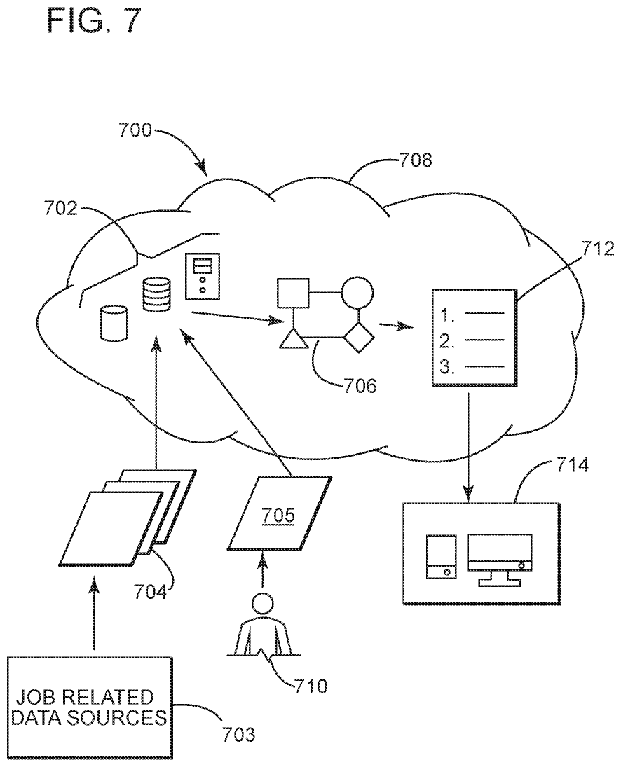

For example, in the Catalog Phase 102A the collected criteria may include an end user's name, email and whether the end user is a job seeker (candidate) looking to be hired for a new job or an employer looking to hire (posting) a job candidate for a new job. This data may be collected prior to the end user paying a fee for use of the computer system 700, 900 (see FIGS. 7-9) that hosts and/or executes the computer implemented method 100.

During the catalog phase 102A, the data/criteria may be collected by several different methods. For example, the data may be collected via a website, wherein the end user creates an account, including an account user name and a password. Alternatively, the data may be collected manually.

During the Criteria Phase 102B, more detailed information may be collected to get a more in-depth knowledge of the end user's goals and other job search criteria. If a fee has been paid, then presumably the end user is invested, and therefore incentivized, in inputting the more detailed information into the system.

During the Criteria Phase 102B an end user may be subjected to additional surveys or interviews to determine such information as:
the compensation level the end user wants to make in the new job or to pay a newly hired job candidate;
a detailed description of the new job the end user is searching or posting;
the title of the new job;
the company size affiliated with the new job;
the industry affiliated with the new job; and/or
the geographic area the end user wants to be physically located;

In addition to determining what an end user is seeking a new job or job candidate, the Criteria Phase may be used to determine what would be unacceptable or irrelevant to an end user. For example, surveys or interviews with the end user may be utilized to determine:
what criteria would not be acceptable to the end user in a new job or job candidate; or
what criteria or types of jobs or job candidates would an end user not be interested in.

At step 104, the computer implemented method 100 enters a “Collect Phase”, wherein a plurality of job related data sets are input into a database 702 (see FIG. 7) stored in the computer system 700. The job related data sets may be derived from a plurality of sources of job related data. The Collect Phase 104 may be performed before, during or after the Catalog and Criteria Phases 102A, 102B.

Data may be collected during the Collect Phase 104 utilizing a variety of different techniques and from a variety of different sources. For example:
Data may be collected from publically listed third party vendors, like Indeed, Google Jobs, Linkedin, Glassdoor, Ziprecruiter or the like.
Strategic partnerships, for example with recruiting firms, may be formed to share data.
Data may be collected via crawlers, application programming interface (API) integration techniques, manual input, robot automation or the like.

Additionally, the data may be evaluated, for example via robot automation techniques, for the quality of data supplied by the sources of job related data. For example, data sources that have a high percentage of old data, or don't regularly update their data, may be discounted more than data sources which update their data on a regular basis.

At step 106, the computer implemented method 100 enters a “Normalize Phase”, wherein the job related data sets and the job search criteria are organized into a consistent format. Once normalized, the data sets may be more easily utilized for downstream processing. For example, the data may be organized as follows:
1) Company or candidate name
2) Company size
3) Company or candidate contacts
4) Company hiring trends
5) Company roles
6) Company or candidate compensation information
7) Company or candidate news and review.

At step 108, the computer implemented method 100 enters a “De-Duplicate Phase”, wherein all extraneous or erroneous information is removed from the data sets. The De-Duplicate Phase may be considered a sub-set of the Normalize Phase.

At step 110, the computer implemented method 100 enters a “Leveling (or Classify) Phase”, wherein the data sets are leveled utilizing one or more algorithms that employ artificial intelligence (AI) techniques. Such AI techniques may include, for example, machine learning techniques that automatically improve with experience.

Leveling herein includes determining equivalencies of data, such as requirements listed in job search criteria or qualifications listed in job related data sets, based on the overall context in which the equivalent data is presented and utilized. Leveling emphasizes the use and context of equivalent data more so than the labeling of the equivalent data. The leveling enables comparison and ranking of such data equivalencies so that they may be presented to an end user for evaluation.

Leveling 110 may involve a comparing step 110A and a ranking step 110B. During the comparing step 110A, the computer implemented algorithm compares the entirety of the requirements of the job search criteria of an end user to the entirety of the qualifications of various job related data sets of available jobs or candidates that are stored in the data base 702. During the ranking step 110B, the algorithm ranks the available jobs or available job candidates in order of most closely meeting the entirety of the job search criteria based on the comparing step 110A.

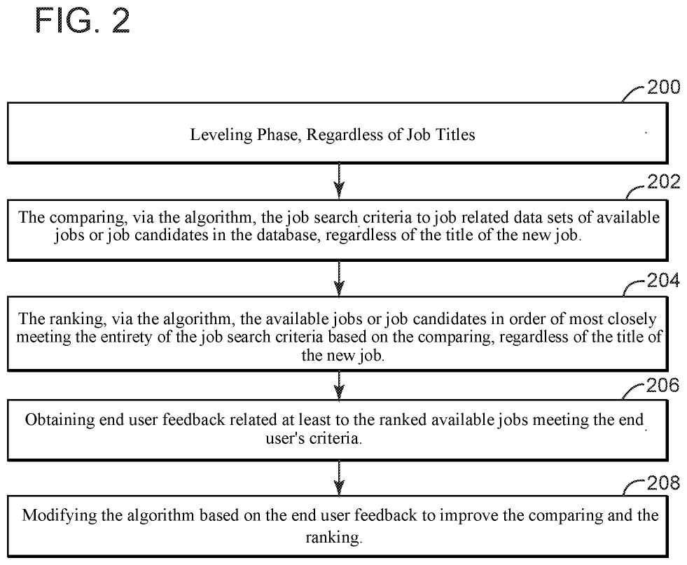

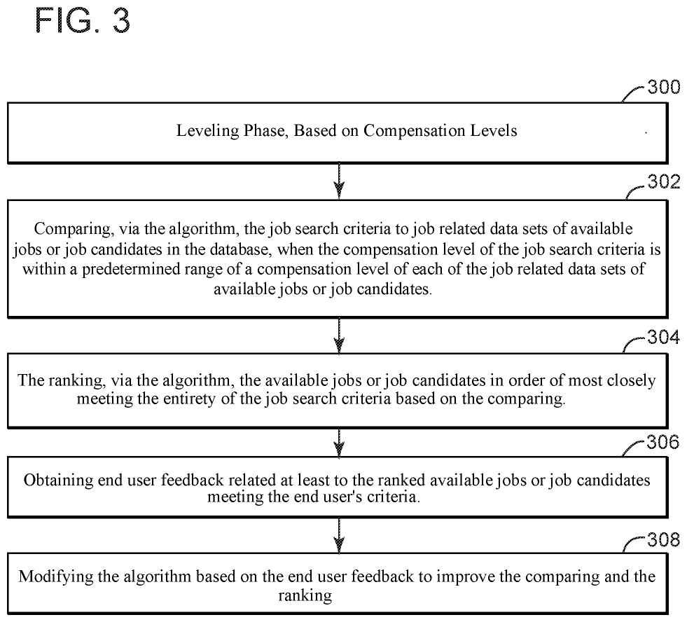

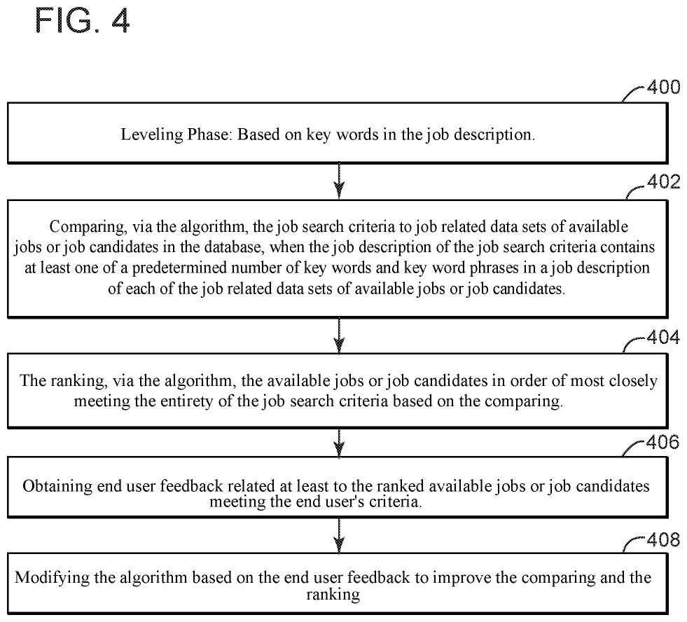

As will be discussed in greater detail herein, and more specifically with regards to FIGS. 2-4, various conditions may be imposed on the leveling process 110 to further enhance the leveling process. For example, leveling may be based on the comparing step 110A and ranking step 110B being done regardless of the job title (FIG. 2). Also by example, leveling 110 may be based on compensation levels being within a certain range (FIG. 3). Also by way of example, leveling 110 may be based on certain number or types of key words or phrases in the job description (FIG. 4).

During leveling, the available jobs or job candidates are ranked based off of the criteria that the end user provides. For example, a company end user may provide 10 specific criteria (e.g., compensation, experience, certain colleges graduated from, etc.) for a new position in the company. Utilizing the computer implemented method 100, candidate one, candidate two and candidate three may be listed as the 3 top candidates for the company to review. Candidate one may hit 9 of the 10 criteria listed by the end user and was ranked first at 90%. Candidate two may hit 85% of the criteria, but has one less year of experience the end user specified in its job search criteria and was, therefore, ranked second. Finally, candidate three may hit 80% of the criteria, but have a good deal more experience listed in the end user's criteria and may have a current compensation level that is above the compensation level listed by the end user. Therefore, candidate three was ranked third in the list of job candidates for the end user to evaluate.

By contrast, prior art methods do not rank available jobs or job candidates based on how closely the available job or job candidate meets the entirety of the job search criteria. Rather, prior art methods will provide an unranked list of jobs or job candidates that have the same job title as that listed in the job search criteria. As a result, the end user is often required to sift through long lists of available jobs or job candidates, that may or may not be relevant to the end user's needs.

Additionally, the AI computer implemented algorithm learns with each iteration of the leveling step 110. Moreover, each new job search criteria provided by an end user may be added to the data base as a data set of job related data.

At step 112, the computer implemented method 100 enters an “Interaction Phase.” During the Interaction Phase 112, an end user's interaction with the method 100 is tracked to modify and improve the computer implemented algorithm and to optimize overall end user outcomes via artificial intelligence.

The Interaction Phase 112 may include an obtaining step 112A and a modifying step 112B. During the obtaining step 112A, end user feedback is obtained, which is related at least to the ranked available jobs or job candidates meeting the end user's job search criteria. During the modifying step 112B, the algorithm is modified based on the end user feedback to improve the comparing step 110A and the ranking step 110B of the Leveling Phase 110.

For example, during the obtaining step 112A, the end user feedback may be related at least to success of the end user in searching for a job or in posting for a job. This feedback may be used to improve the computer implemented algorithm's ability to provide rankings of available jobs or available candidates that are more likely to enable an end user to be successful.

Also by example, during the modifying step 112B, the computer implemented algorithm 706 may be modified by at least adding the job search criteria to the database as a job related data set. The more relevant information that is added to the database 702, the more the algorithm 706 will learn from experience and the more the algorithm's performance will improve.

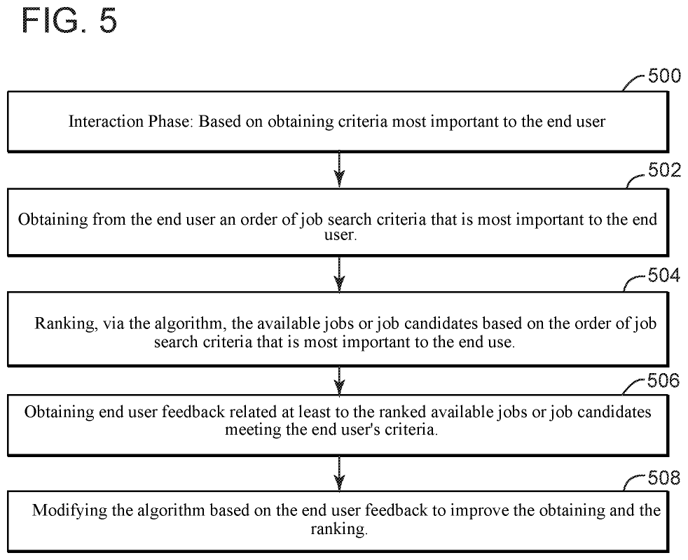

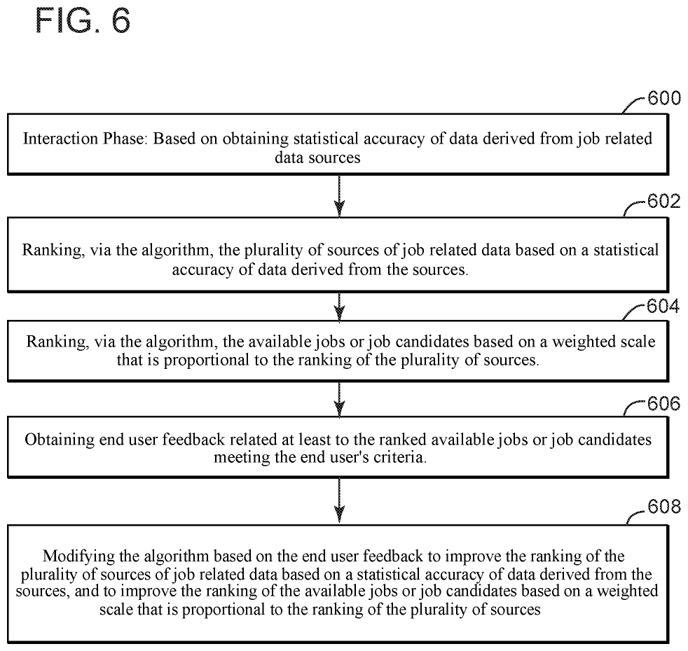

As will be discussed in greater detail herein, and more specifically with regards to FIGS. 5-6, various conditions may be imposed on the Interaction Phase 112 to further enhance the interaction process. For example, the Interaction Phase 112 may be based on job search criteria that is most important to the end user (FIG. 5). Also by example, the Interaction Phase 112 may be based on the relative statistical accuracies of data derived from job relate data sources (FIG. 6).

At step 114, the computer implemented method 100 enters a “Warehouse Phase”, wherein data is stored in the database 706. As will be discussed in greater detail herein, the data may be stored by many different techniques and technologies, including, for example, cloud SQL.

At step 116, the computer implemented method 100 enters a “Visualize Phase”, wherein the data is organized for presentations that may be easily understood by an end user. Such presentations may include graphs and/or tables.

At step 118, the computer implemented method 100 enters a “Report Phase.” Reports generated during the Report Phase 118 may include a written ranking of the available jobs or job candidates to be presented to the end user prior the Interaction Phase 112. Additionally, the reports may be geared for human resource professionals and may include, for example, an analysis of job seeker trends over an entire country.

Though FIGS. 1A and 1B have illustrated the steps 102-118 in a certain order, it should be noted that other orders of these steps are within the scope of the present invention. For example, the Collect Phase 104 may be implemented before, during or after the Catalog Phase 102A or the Criteria Phase 102B. Also, by way of example, the Warehouse Phase 114, Visualize Phase 116 and/or Report Phase 118 may be implemented before during or after the Interaction Phase 112.

Referring to FIG. 2, an example of a flow diagram of another embodiment of a Leveling Phase 200 of the computer implemented method of employment 100 is depicted in accordance with aspects of the present invention. As was discussed earlier, various conditions may be imposed on the Leveling Phase to further enhance the leveling process. In this embodiment 200 of a Leveling Phase the job search criteria is compared to the job related data sets regardless of the job titles involved.

At step 202, the computer implemented algorithm compares the job search criteria to job related data sets of available jobs or job candidates in the database, regardless of the title of the new job. Because job titles have no uniform standard or governance between industries or even between companies in the same industry, job titles for essentially the same position will vary significantly between companies. For example, a director of marketing at one company may be called a vice president of marketing at another company. Yet, because prior art job search algorithms often key primarily on the job title, available jobs or job candidates with the different titles for essentially the same job will often be missed during a job or candidate search.

Additionally, a marketing manager at a large company may have the qualifications to fulfill a position as director of marketing for a small to medium sized company. Also, a vice president of marketing at a small to medium sized company may have the qualification to fulfill a position as director of marketing for a larger company.

So in this step 202, the algorithm would compare the entirety of the job search criteria to the entirety of each data set of available jobs or job candidates, accept for the title associated with the job or candidate. Alternatively, the algorithm may not disregard the titles all together, but instead attribute less weight to the title and more weight to other features in the job search criteria. Such other features may include the job description, experience, number of people a person doing the job would be required to manage or the compensation level of the job.

At step 204, once the comparing is done, the algorithm ranks the available jobs or job candidates in order of most closely meeting the entirety of the job search criteria based on the comparing step 202. Again, this would be done regardless of the title associated with the new job.

At step 206, once the ranking 204 is completed, the algorithm obtains feedback from the end user that is related at least to the ranked available jobs or job candidates meeting the end user's criteria. The feedback may be obtained in several ways. For example, the feedback may be obtained by first providing a report of the rankings (such as described in the Report Phase 118), which prompts the feedback from the end user. Also feedback may be obtained by any type of oral or written correspondence with the end user, such as by email correspondence or surveys provided to the end user. The feedback may include several subjects. For example, the feedback may be information from the end user on how relevant the end user believes the ranked jobs or job candidates are to his needs. The feedback may also include information on how successful the end user was in obtaining his goals through use of the rankings.

At step 208, the algorithm is modified based on the end user feedback to improve the comparing 202 and the ranking 204 steps. For example, the algorithm may be modified based on the degree of success the end user had when utilizing the ranked jobs or job candidates.

Referring to FIG. 3, another example of a flow diagram of an embodiment of a Leveling Phase 300 of the computer implemented method of employment 100 is depicted in accordance with aspects of the present invention. In this embodiment 300 of the Leveling Phase the job search criteria is compared to the job related data sets based on compensation levels of the job search criteria and job related data sets being within a certain range.

At step 302 of this embodiment, the computer implemented algorithm compares the job search criteria to job related data sets of available jobs or job candidates in the database. However, the comparison is done only when the compensation level of the job search criteria is within a predetermined range of the compensation level of each of the job related data sets of available jobs or job candidates.

The comparing may be performed when the compensation level of the job search criteria is within plus or minus 30 percent, plus or minus 20 percent, plus or minus 10 percent or plus or minus 5 percent of the compensation level of each of the job related data sets of available jobs or job candidates. For example, if the predetermined range is determined to be plus or minus 10 percent and the compensation level of the job search criteria is $100,000, then the algorithm will only compare the job search criteria to job relate data sets that have a compensation level within a range of $90,000 to $110,000.

At step 304, once the comparing is done, the algorithm ranks the available jobs or job candidates in order of most closely meeting the entirety of the job search criteria based on the comparing step 302. Again, this would be done for job related data sets that have compensation levels within the predetermined range of the job search criteria's compensation level.

Alternatively, the predetermined range of compensation level required to initiate the comparing process may be a threshold range. For example, the algorithm may compare job search criteria to job relate data sets that have a compensation level that is no less than 10 percent of the criteria compensation level, but may exceed the criteria compensation level by any amount.

At step 306, once the ranking 304 is completed, the algorithm obtains feedback from the end user that is related at least to the ranked available jobs or job candidates meeting the end user's criteria. The feedback may be obtained in several ways. For example, the feedback may be obtained by first providing a report of the rankings (such as described in the Report Phase 118), which prompts the feedback from the end user. Also, feedback may be obtained by any type of oral or written correspondence with the end user, such as by email correspondence or surveys provided to the end user. The feedback may include several subjects. For example, the feedback may be information from the end user on how relevant the end user believes the ranked jobs or job candidates are to his needs. The feedback may also include information on how successful the end user was in obtaining his goals through use of the rankings.

At step 308, the algorithm is modified based on the end user feedback to improve the comparing 302 and the ranking 304 steps. For example, the algorithm may be modified based on the degree of success the end user had when utilizing the ranked jobs or job candidates.

Referring to FIG. 4, another example of a flow diagram of an embodiment of a Leveling Phase 400 of the computer implemented method of employment 100 is depicted in accordance with aspects of the present invention. In this embodiment 400 of the Leveling Phase the job search criteria is compared to the job related data sets based on key words, key word phrases and/or combinations of both in the job description.

At step 402 of this embodiment, the computer implemented algorithm compares the job search criteria to job related data sets of available jobs or job candidates in the database. However, the comparison is done only when the job description of the job search criteria contains at least one of a predetermined number of key words and key word phrases in a job description of each of the job related data sets of available jobs or job candidates.

For example, a job search criteria for a marketing director may contains key words such as “direction”, “guidance” and/or “leadership” found within one or two words of the word “marketing” or the phrase “marketing department.” If that same combination of key words and phrases are found in a job description of a job related data set of an available job then the algorithm may compare the entirety of the job search criteria to the entirety of the job related data set.

At step 404, once the comparing is done, the algorithm ranks the available jobs or job candidates in order of most closely meeting the entirety of the job search criteria based on the comparing step 402.

At step 406, once the ranking 404 is completed, the algorithm obtains feedback from the end user that is related at least to the ranked available jobs or job candidates meeting the end user's criteria. The feedback may be obtained in several ways. For example, the feedback may be obtained by first providing a report of the rankings (such as described in the Report Phase 118), which prompts the feedback from the end user. Also feedback may be obtained by any type of oral or written correspondence with the end user, such as by email correspondence or surveys provided to the end user. The feedback may include several subjects. For example, the feedback may be information from the end user on how relevant the end user believes the ranked jobs or job candidates are to his needs. The feedback may also include information on how successful the end user was in obtaining his goals through use of the rankings.

At step 408, the algorithm is modified based on the end user feedback to improve the comparing 402 and the ranking 404 steps. For example, the algorithm may be modified based on the degree of success the end user had when utilizing the ranked jobs or job candidates.

FIGS. 2, 3 and 4 illustrate three embodiments of a Leveling Phase 200, 300, 400 that may be used separately or in any combination. For example, the comparison and ranking steps of a Leveling Phase may be based on compensation levels as discussed in the embodiment of FIG. 3 and may also be performed regardless of the job title as discussed in the embodiment of FIG. 2.

For example, the compensation level of a job search criteria may be $100,000. Further, the comparison step in the Leveling Phase may be conditioned upon the compensation level of the job related data sets being within plus or minus 10 percent of the compensation level of the job search criteria (similar to the example discussed in FIG. 3). Further the comparison step may required to be performed regardless of the job titles matching (similar to the example discussed in FIG. 2). Accordingly, during the Leveling Phase, the algorithm will compare the job search criteria to job relate data sets that have a compensation level within a range of $90,000 to $110,000, regardless of the job titles matching.

Moreover, other conditions may be imposed on the leveling process beside those discussed in FIGS. 2, 3 and 4. For example, rather than leveling regardless of a job title, the leveling process may be performed when job titles are similar. For example, when job titles are one of a table of similar job titles, such as director of marketing, marketing manager or vice president of marketing.

Referring to FIG. 5, an example of a flow diagram of another embodiment of an Interaction Phase 500 of the computer implemented method of employment 100 is depicted in accordance with aspects of the present invention. As was discussed earlier, various conditions may be imposed on the Interaction Phase to further enhance the interaction process. In this embodiment 200, the Interaction Phase 500 is based on obtaining job search criteria that is most important to the end user.

At step 502, job search criteria is obtained from the end user that is most important to the end user. Obtaining such job search criteria may be done in several ways. For example, the job search criteria most important to the end user may be obtained by interviewing the end user, by searching various websites for information on the end user (such as Linkedin), by questionnaires provided to the end user, or by any other type of oral or written correspondence with the end user.

At step 504, once the criteria is obtained, the algorithm ranks the available jobs or job candidates based on the order of job search criteria that is most important to the end use. For example, if the most important criteria to the end user is the job's physical location, then the most highly ranked jobs will more likely be located closest to that location.

At step 506, once the ranking 504 is completed, the algorithm obtains feedback from the end user that is related at least to the ranked available jobs or job candidates meeting the end user's criteria. The feedback may be obtained in several ways. For example, the feedback may be obtained by first providing a report of the rankings (such as described in the Report Phase 118), which prompts the feedback from the end user. Also feedback may be obtained by any type of oral or written correspondence with the end user, such as by email correspondence or surveys provided to the end user. The feedback may include several subjects. For example, the feedback may be information from the end user on how relevant the end user believes the ranked jobs or job candidates are to his needs. The feedback may also include information on how successful the end user was in obtaining his goals through use of the rankings.

At step 508, the algorithm is modified based on the end user feedback to improve the obtaining 502 and the ranking 504 steps. For example, the algorithm may be modified based on the degree of success the end user had when utilizing the ranked jobs or job candidates.

Referring to FIG. 6, an example of a flow diagram of another embodiment of an Interaction Phase 600 of the computer implemented method of employment 100 is depicted in accordance with aspects of the present invention. In this embodiment, the Interaction Phase 600 is based on obtaining statistical accuracy of data derived from job related data sources.

At 602, the algorithm ranks the plurality of sources of job related data based on a statistical accuracy of data derived from the sources. Often the data in a job related source of data may be old or inaccurate. For example, a person's profile in a data source, such as Linkedin, may not have been updated for quite some time and may not accurately reflect the current qualifications of that person. For an additional example, addresses of people and/or companies may change and may not be accurately listed in a data source. Job related data sources that consistently show higher percentages of old or inaccurate data will introduce inaccuracies in the comparison and ranking steps of the Leveling Phase. Therefore, in order to reduce or avoid the influence of inaccurate sources during the Leveling Phase or Interaction Phase of the method, the algorithm may rank the sources of job related data based on the statistical accuracy of the data those sources contain.

At 604, the algorithm may rank the available jobs or job candidates based on a weighted scale that is proportional to the ranking performed at step 602 of the plurality of sources. In other words, a job or job candidate from a relatively inaccurate data source may be ranked lower than a job or job candidate from a relatively accurate data source even if the data sets of both job or job candidate are essentially equal.

For example, if a first data source updates a job candidate's experience level and compensation every year, it may be considered to be more accurate than a second data source that does not update a job candidate's experience and compensation level for several years. Therefore, the first data source will be ranked higher for statistical accuracy than the second data source. Accordingly, even if a job candidate from the first data source does not match the job search criteria of an end user quite as well as a candidate from the second data source, the job candidate from the first data source may be ranked as a closer fit.

At step 606, once the ranking 604 is completed, the algorithm obtains feedback from the end user that is related at least to the ranked available jobs or job candidates meeting the end user's criteria. The feedback may be obtained in several ways. For example, the feedback may be obtained by first providing a report of the rankings (such as described in the Report Phase 118), which prompts the feedback from the end user. Also feedback may be obtained by any type of oral or written correspondence with the end user, such as by email correspondence or surveys provided to the end user. The feedback may include several subjects. For example, the feedback may be information from the end user on how relevant the end user believes the ranked jobs or job candidates are to his needs. The feedback may also include information on how successful the end user was in obtaining his goals through use of the rankings.

At step 608, the algorithm is modified based on the end user feedback to improve the ranking (in step 604) of the plurality of the sources of job related data based on a statistical accuracy of data derived from the sources. In other words, based on an end user's feedback, if the data from a data source that was ranked with a low accuracy rating proves to be reliable, than that data source's accuracy rating may improve. Accordingly, the data from that data source may be given more weight during the algorithm's analysis.

### Computer System and Computer Implemented Algorithm

The following FIGS. 7-9 and the following disclosure associated with those figures depict aspects in accordance with the present invention, of computer systems and computer implemented algorithms utilized to implement the method of employment 100.

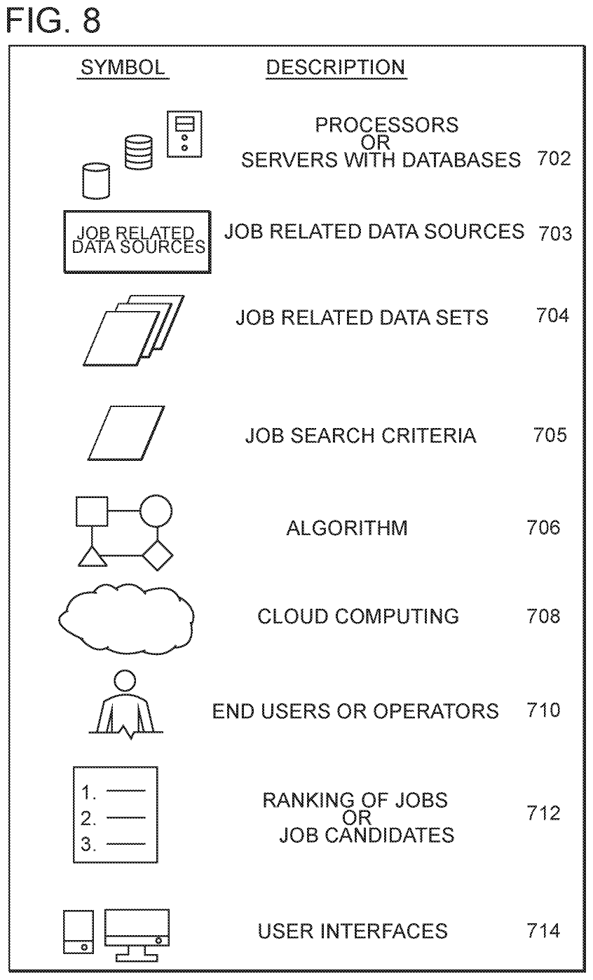

Referring to FIGS. 7 and 8, aspects of a computer system 700 in accordance with an exemplary embodiment of a computer implemented method of employment 100 is disclosed. The method 100 of employment includes inputting a plurality of job related data sets 704 derived from a plurality of job related data sources 703 into a database 702 stored in the computer system 700. The method also includes collecting job search criteria 705 from an end user 710, wherein the job search criteria 705 includes at least a description of a new job, a title of the new job and a compensation level of the new job. The method normalizes the job related data sets 704 and the job search criteria 705 into a consistent format for downstream processing. The method includes a computer implemented algorithm 706, which is utilized to compare the job search criteria 705 to job related data sets 704 of available jobs or job candidates in the database 702. The method also utilizes the algorithm 706 to rank the available jobs 712 in order of most closely meeting the entirety of the job search criteria 705 based on the comparison.

The system 700 may include one or more processors and/or servers with one or more databases 702. The job related data sets 704 and job search criteria 705 are processed via the computer implemented algorithm 706. In one example, the system 700 may be implemented via cloud computing 708.

The system 700 receives or obtains job related data sets 704 from a plurality of job related data sources 703. The job related data sources 703 can be any viable source of job related data or information, such as for example, individuals, other databases, the internet, social media, industry reports, resumes or job postings to a job board. The job related data sets 704 may represent information about jobs or job candidates. At least a portion of the job related data sets 704 include information about currently available jobs or currently available job candidates. The job related data sets 704 may include descriptions of jobs, compensation levels of jobs, job titles, locations of jobs, companies offering the jobs and more. The job related data sets 704 may also include candidates available for jobs, experience levels of candidates, educational background of candidates, resumes of candidates, companies that the candidates work for, physical location of candidates and more.

The system 700 also receives or obtains job search criteria 705 from end users 710. The job search criteria 705 may represent information about jobs the end users are seeking and/or jobs the end users 710 are posting. The job search criteria 705 may include descriptions of jobs, compensation levels of jobs, job titles, locations of jobs, companies offering the jobs and more. The job search criteria 705 may also include candidates available for jobs, experience levels of candidates, educational background of candidates, resumes of candidates, companies that the candidates work for, physical location of candidates, location preference of candidates and more.

The job related data sets 704 and job search criteria 705 may be obtained by any viable method including receiving such information from a computer or mobile device. The job search criteria 705 may also be input by the end users 710. Other techniques for obtaining information may also be used to create, generate, and/or obtain the same. Within the system 700 and memory associated therewith, the job related data sets 704 and job search criteria 705 may be stored in any desirable format in one or more databases 702.

A process or algorithm 706 performed by the processor 702 may use the job related data sets 704 and job search criteria 705 to generate results 712. The results 712 may electronically represent a comparison of the job search criteria 705 to the job related data sets 704. The results 712 may also electronically represent a ranking of available jobs or job candidates in order of most closely meeting the entirety of the job search criteria. The system may also modify the algorithm 706 via artificial intelligence techniques to improve the comparison and the ranking. The system 700 may also store the results 712 for later use or analysis.

Users 710 may be enabled to view the results 712 on any number of user interfaces 714. The users 710 may also be allowed to input further job search criteria through the user interfaces 714. The users 710 may also be allowed to input user feedback on the results 712 through the user interfaces 714. The user feedback may be used to modify and improve the ability of the algorithm 706 to compare and rank job related data sets 704 relative to the job search criteria 705 and to provide results 712 that better enable an end user 710 to meet the end user's goals.

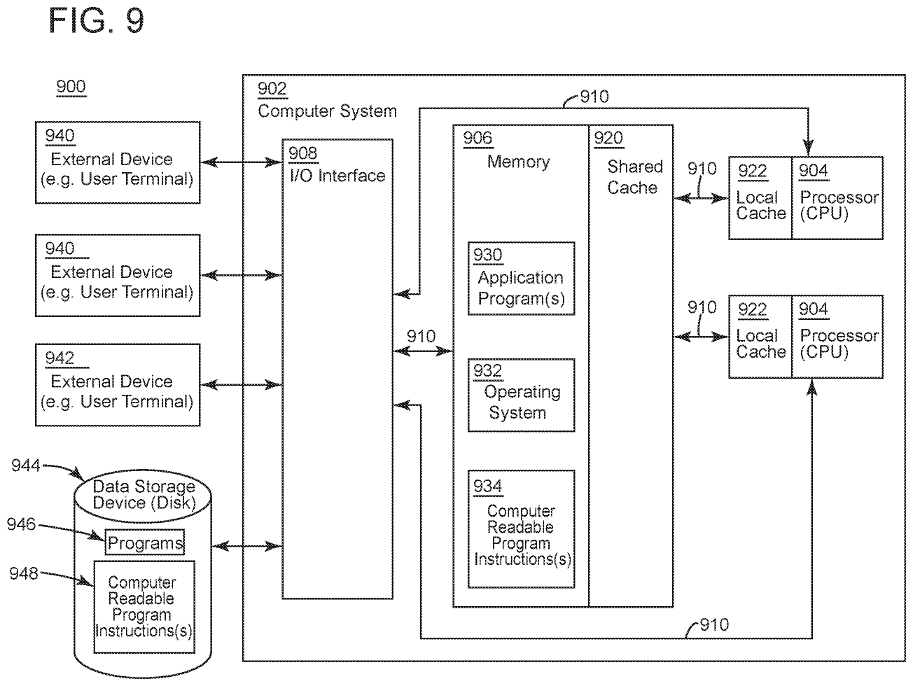

Referring to FIG. 9, an example of a computing environment 900 useable to perform the method 100 of this invention is disclosed. For example, the computing environment 900 may be included in the computer system 700 of FIG. 7. Also, by example, the computing environment 900 may be a processor or server with a data base 702, as also illustrated in FIG. 7.

The computing environment 900 includes, for instance, a computer system 902 shown, e.g., in the form of a general-purpose computing device. Computer system 902 may include, but is not limited to, one or more processors or processing units 904 (e.g., central processing units (CPUs)), a memory 906 (a.k.a., system memory, main memory, main storage, central storage or storage, as examples), and one or more input/output (I/O) interfaces 908, coupled to one another via one or more buses and/or other connections 910.

Bus 910 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 906 may include, for instance, a cache 920, such as a shared cache, which may be coupled to local caches 922 of processors 904. Further, memory 906 may include one or more programs or applications 930, an operating system 932, and one or more computer readable program instructions 934. Computer readable program instructions 934 may be configured to carry out and perform the process of the method of the present invention including all functions of embodiments of aspects of the invention.

Computer system 902 may also communicate via, e.g., I/O interfaces 908 with one or more external devices 940, one or more network interfaces 942, and/or one or more data storage devices 944. Example external devices include a user terminal, a tape drive, a pointing device, a display, etc. Network interface 942 enables computer system 902 to communicate with one or more networks, such as a local area network (LAN), a general wide area network (WAN), and/or a public network (e.g., the Internet), providing communication with other computer devices or systems. For example, the system may be connected to a personal computer, tablet device or smart phone to communicate the assigned or unassigned status of mobile objects to user via a graphical user interface.

Data storage device 944 may store one or more programs 946, one or more computer readable program instructions 948, and/or data, etc. The computer readable program instructions may be configured to carry out and perform the process of the method of the present invention including all functions of embodiments of aspects of the invention.

Computer system 902 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 902. Examples, include, but are not limited to: microcode, device drivers, redundant processing units, external disk drive arrays, RAID systems, tape drives, and data archival storage systems, etc.

Computer system 902 may be operational with numerous other general purposes or special purpose computing system environments or configurations. Examples of well-known computing systems, environments, and/or configurations that may be suitable for use with computer system 902 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

One or more of the processors and/or other aspects of the computer system or computing environment may be remote from the mobile object. Further, in one particular example, a processor, such as processor 904, may execute, in accordance with one or more aspects of the present invention, one or more machine learning engines and/or other engines to provide, based on training and learning, an optimal travel route or path for mobile object. These engines may be stored in memory, including main memory and/or one or more caches, and/or external storage, and may be executed on one or more processors. Many variations exist.

One or more aspects of the present invention are inextricably tied to computer technology and/or to the improvement of a technical field.

One or more aspects may relate to cloud computing. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages such as Angular, HTML, CSS, .NET Framework, C# and Microsoft SQL Server, and including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different types of unmanned aerial vehicles may be used, as well as other types of neural networks and/or evolutionary algorithms. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

It should be appreciated that all combinations of the foregoing concepts and additional concepts discussed in greater detail herein (provided such concepts are not mutually inconsistent) are contemplated as being part of the inventive subject matter disclosed herein and to achieve the benefits and advantages as described herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A computer implemented method of employment, the method comprising:
collecting job search criteria from an end user, the job search criteria comprising at least a description of a new job, a title of the new job and a compensation level of the new job;
inputting a plurality of job related data sets of jobs or job candidates derived from a plurality of sources of job related data into a database stored in a computer system;
normalizing the job related data sets and the job search criteria into a consistent format;
comparing, via computer implemented algorithm, the job search criteria to job related data sets of available jobs or job candidates in the database; and
ranking, via the algorithm, the available jobs or job candidates in order of most closely meeting the entirety of the job search criteria based on the comparing.

2. The method of claim 1, comprising:
obtaining end user feedback related at least to the ranked available jobs or job candidates meeting the end user's job search criteria;
modifying the algorithm based on the end user feedback to improve the comparing and the ranking.

3. The method of claim 2, wherein modifying the algorithm comprises at least adding the job search criteria to the database as a job related data set.

4. The method of claim 2, wherein obtaining end user feedback comprises obtaining end user feedback related at least to success of the end user in searching for a job or in posting for a job candidate.

5. The method of claim 1, comprising leveling the job search criteria, wherein leveling comprises:
the comparing being performed via the algorithm, regardless of the title of the new job; and
the ranking being performed via the algorithm, regardless of the title of the new job.

6. The method of claim 5, wherein leveling comprises:
obtaining end user feedback related at least to the ranked available jobs or job candidates meeting the end user's criteria; and
modifying the algorithm based on the end user feedback to improve the comparing and the ranking.

7. The method of claim 5, wherein leveling further comprises:
the comparing being performed via the algorithm, when the compensation level of the job search criteria is within a predetermined range of a compensation level of each of the job related data sets of available jobs or job candidates.

8. The method of claim 7, wherein the compensation level of the job search criteria is within plus or minus 10 percent of the compensation level of each of the job related data sets of available jobs.

9. The method of claim 5, wherein the leveling further comprises:
the comparing being performed via the algorithm, when the job description of the job search criteria contains at least one of a predetermined number of key words and key word phrases in a job description of each of the job related data sets of available jobs of job candidates.

10. The method of claim 1, wherein collecting job search criteria from an end user comprises determining criteria that would not be acceptable to the end user.

11. The method of claim 1, comprising:
obtaining from the end user an order of job search criteria that is most important to the end user; and
ranking, via the algorithm, the available jobs based on the order of job search criteria that is most important to the end use.

12. The method of claim 1, comprising:
ranking, via the algorithm, the plurality of sources of job related data based on a statistical accuracy of data derived from the sources; and
ranking, via the algorithm, the available jobs or job candidates based on a weighted scale that is proportional to the ranking of the plurality of sources.

13. The method of claim 12, comprising:
obtaining end user feedback from the end user related to the ranked available jobs meeting the end user's criteria; and
modifying the computer implemented algorithm based on the end user feedback to improve the ranking of the plurality of sources of job related data based on a statistical accuracy of data derived from the sources, and to improve the ranking of the available jobs based on a weighted scale that is proportional to the ranking of the plurality of sources.

14. A computer implemented method of employment, the method comprising:
collecting job search criteria from an end user, the end user searching for a job or posting for a job candidate, the job search criteria comprising at least a description of a new job, a title of the new job and a compensation level of the new job;
inputting a plurality of job related data sets derived from a plurality of sources of job related data into a database stored in a computer system;
normalizing the job related data sets and the job search criteria into a consistent format; and
leveling the job search criteria, wherein leveling comprises:
comparing, via computer implemented algorithm, the job search criteria to job related data sets of available jobs of job candidates in the database, regardless of the title of the new job, and
ranking, via the algorithm, the available jobs of job candidates in order of most closely meeting the entirety of the job search criteria based on the comparing.

15. The method of claim 14, comprising:
obtaining end user feedback related at least to the ranked available jobs or job candidates meeting the end user's criteria, regardless of the title of the new job;
modifying the algorithm based on the end user feedback to improve the comparing and the ranking; and
adding the job search criteria to the database as a job related data set.

16. The method of claim 15, wherein the end user feedback is related at least to success of the end user in searching for a job or in posting for a job candidate.

17. The method of claim 14, wherein leveling further comprises:
the comparing, being performed via the algorithm, when the compensation level of the job search criteria is within a predetermined range of a compensation level of each of the job related data sets of available jobs or job candidates.

18. The method of claim 17, wherein the compensation level of the job search criteria is within plus or minus 10 percent of the compensation level of each of the job related data sets of available jobs or job candidates.

19. The method of claim 17, wherein the leveling further comprises:
the comparing, being performed via the algorithm, when the job description of the job search criteria contains at least one of a predetermined number of key words and key word phrases in a job description of each of the job related data sets of available jobs or job candidates.

20. The method of claim 14, wherein collecting job search criteria from an end user comprises determining criteria that would not be acceptable to the end user.
